(19) United States
(12) Patent Application Publication
(10) Pub. No.: US 2022/0050172 A1
(43) Pub. Date: Feb. 17, 2022

(54) SYSTEM AND METHOD FOR CALIBRATING SENSOR MEASUREMENTS TO DETERMINE THE MOTION CHARACTERISTICS OF A MOVING OBJECT

(71) Applicant: Invention Planet, LLC, Santa Rosa, CA (US)

(72) Inventors: Grant Moulton, Santa Rosa, CA (US); Steven Goody, Santa Rosa, CA (US); Christopher Stewart, Santa Rosa, CA (US); Francois Piccin, Santa Rosa, CA (US); Jason McGuire, Santa Rosa, CA (US)

(73) Assignee: Invention Planet, LLC, Santa Rosa, CA (US)

(21) Appl. No.: 17/445,038

(22) Filed: Aug. 13, 2021

Related U.S. Application Data
(60) Provisional application No. 62/706,377, filed on Aug. 13, 2020.

(51) Int. Cl. G01S 7/40; G01S 13/86; G01S 17/42; G01S 7/497; G01S 13/50; G01S 17/50

(52) U.S. Cl. CPC G01S 7/40; G01S 13/867; G01S 17/50; G01S 7/497; G01S 13/50; G01S 17/42

(57) ABSTRACT

A system and method of aligning and calibrating sensor measurements to determine motion characteristics of a moving object. The method involves calibrating a plurality of sensors for a multi-dimensional field of interest, based on one or more of motion data of the moving object, and spatial data and timing synchronization of the plurality of sensors, to obtain first measurements. The method also includes determining initial estimate of one or more of location, velocity, spin, and spin axis of the moving object from the first measurements. It compares succeeding sets of measurements with the determined initial estimate to modify the initial estimate, wherein the succeeding set of measurements are obtained from the plurality of sensors. It then determines the motion characteristics of the moving object based on the modification of the initial estimate.

### BACKGROUND OF THE INVENTION

### Field of the Invention

The present invention relates most generally to a motion sensor calibration system, and more particularly to a multi-sensor calibration system for determining motion characteristics of moving objects.

### Background Discussion

Current systems for measuring the characteristics of a moving object, such as the speed and trajectory of the object, require the physical measurement of the location and the manual orientation and positioning of sensors in both time and space. (Note should be made that there are numerous ways to correlate multiple sensors and compensate for latency and updating rate, including time, trigger, and location, or combinations of the three. These various options are understood to be known by those with skill in the art.) Although many individual sensors may be used to measure object speed and trajectory, individual sensors when used alone do not deliver entirely reliable information. To begin with, each sensor has its own range and resolution limitations, as well as some latency in updating speed, among other things. Impractically, in known prior art systems, individual sensors must be nearly perfectly aligned to the trajectory of the moving object for the sensors to provide accurate measurements, and such a condition is difficult to achieve because the trajectory of the moving object may vary widely, especially when taking repeated measurements of different trajectories, and real-world performance conditions make such an alignment difficult to achieve. This is especially true when measuring the trajectory and speed of balls and other projectiles in sports. Systems that include both the indicated capabilities and the limitations include many marketed and sold through Rapsodo Pte. Ltd of Singapore. Several have been the subject of patents, including those in a short but exemplary list: U.S. Pat. No. 10,754,025 to Asghar, U.S. Pat. No. 10,733,758 to Jin, et al, U.S. Pat. No. 10,593,048 to Keat et al, and U.S. Pat. No. 10,835,803 to Okur, et al.

As noted above, individual sensors have limitations in their ability to measure physical objects with perfect fidelity, particularly with respect to objects in motion. Each kind of sensor has range limitations, resolution limitations, speed of update limitations, and then more specific limitations that apply uniquely to the particular kind of sensor.

With respect to motion, in particular, sensors such as Radio Detection and Ranging (radar) and Light Detection and Ranging (lidar), and the like are used to detect object velocity. However, radar has limitations in both the transmitted power and in noise cancellation which, along with the amount of returning radar signal from any object, sets the distance range within which it may operate. Further, the amount of returning signal decreases for objects with a small cross-sectional surface area and for objects composed of material with low reflection, resulting in inaccurate and inefficient measurements from the radar. Radar devices measure the change in phase of a transmitted radio frequency signal reflected by an object and compare the received phase with the transmitted phase. A moving object creates a systematic change in phase due to the changing radio frequency path length, which might also be observed as a frequency change in the returning waveform for a constant speed of motion. The radar device will only sense the portion of the speed vector aligned along the path of that transmitted radio signal. This gives a slower speed measurement than the actual speed vector by the cosine of the angle between the actual speed vector of the moving object and the vector of the transmitted radar radio frequency signal. Further, the radar may not have directional or distance resolution capacity, depending upon the complexity of the system design. This results in even more uncertainty in measurement resolution for the true trajectory of a moving object. Still further, radar devices have upper limits on transmitted power and have noise limitations which, along with the amount of returning radar signal from any object, set the distance range within which they may operate. The returning signal depends upon the radar cross section of the moving object, which may be very small for small moving objects or for objects with surfaces designed with special shapes or materials that reduce the returning radar signal.

As moving object sensors, cameras can capture single images or a sequence of images in visible, infrared or other electromagnetic wavelengths. However, they have limitations in light sensitivity and exposure time, in lens and sensor resolution, and in focus for objects at multiple distances.

Lidar is also frequently used to measure moving objects. Complex multi-sensor Lidar devices operate by transmitting a laser signal and sensing a returned, reflected signal with an array of sensors typically located behind a lens. This enables identification of the amplitude and timing of the reflected laser light signal. The Lidar has a fixed number of sensors in an array and thus has limitations in angle resolution. This enables angle resolution of the distance to any reflecting object at the particular angle observed by the individual sensor or pixel in the array. Lidar has limitations in the amount of transmitted laser light due to regulatory limits, power source and device limits. It also has limits in the sensitivity of each sensor in the array due to interfering or ambient light (typically infrared). It has a limited level of received signal relative to the intrinsic noise of each sensor in the array, which sets the distance measurement capability (or the range), and a limited amount of acquisition and processing capability that sets the distance resolution of each sensor. Lidar has a limitation on the number of observations per second that it may perform.

Additionally, factors such as temperature, humidity, drag, air resistance, and gravity all affect the trajectory of a moving object. This makes highly accurate modeling of the trajectory of the moving object quite difficult, thereby resulting in inaccurate predictions of the location and velocity at the next measurement of the moving object.

Combining sensors available in many computing devices, such as smartphones, tablets, etc., enable improvement of the measurements taken with those sensors and with other external sensors. Importantly, however, most current systems do not provide an option to combine the measurements from individual sensors, one with one or more others, or with external sensors.

The ability to resolve angle locations of specific objects enables construction of a physical world model. The physical models for many moving objects match reasonably well with how those objects actually move, but they also have limitations. For example, the coefficient of drag for a baseball may vary dramatically depending upon surface condition and wear. This makes simple modeling more difficult, but it still proves useful in understanding the trajectory of the ball. Similar limitations apply for other moving objects, especially those with variable features that influence their motion.

Sensor combinations may be provided in smartphones, the selection of sensors possibly including accelerometers, gyroscopes, compasses, microphones, cameras, Lidar units and a multitude of infrared, optical or radio frequency links, such as Bluetooth, Wifi, Zigbee, infrared or other radio and optical communication methods. There will undoubtedly be future additions to the standard platforms.

And image processing software enables the identification of changes in an image, may recognize patterns previously identified in an image, or may identify changes in the location of a particular recognized pattern versus time. These patterns may include a human body, a moving bat, tennis racquet or other sports implement, a fixture on a playing field such as home plate in a baseball game, net in a volleyball game, or objects on a factory floor, including specific machinery—a forklift or moving bottles along a conveyer path. Almost any arbitrary object might be identified and observed using image processing and proper programming or training of that system.

Early attempts to use accelerometer and gyroscopic sensors in smartphones were not entirely successful in accurately tracking motion of the phone in a three-dimensional model. Even so, those measurements still have utility in improving the physical modeling of the real-world system that uses the measurements the sensors deliver. Using the combination of the device camera and image processing to identify a known object along with the accelerometer, compass and gyroscope to determine motion, pointing and position has the potential to determine and calibrate the location of a field of play such as a baseball field, home plate and other bases, baselines, athletes and the ball and bat.

The ability to easily determine the relative locations of the various objects and persons in question for a given measurement enables alignment of the sensors with the real-world model. The ability to easily determine the relative location of sensors enables the combination of those sensors in a meaningful way to obtain multidimensional results from one or two-dimensional sensors. The ability to easily and automatically determine the relative location of computing devices and sensors such as tablets, standalone computing systems like Raspberry Pi or smart phones as well as specific individual sensors not included in those computing devices greatly improves the utility of the measurement system, because it reduces the complexity of setup and calibration and simplifies operation. This reduces the probability of error whether by the operator or from the limitations of a single sensor. This reduces the time to set up the system and provides more utility due to less time wasted.

The combination of multiple sensors improves the measurement. Time synchronization improves measurement. For example, if multiple radar devices observe the speed of a moving object and are synchronized together in time and calibrated in location, then the actual trajectory of the moving object may be reconstructed using the knowledge gained in the calibration and set up process to map those sensors to the real-world model.

Multiple sensors might obtain time synchronization through optical, radio or similar transmission links. A camera, microphone, Lidar or an accelerometer worn by the athlete or on the sports implement might determine motion and mark the time that a baseball bat, golf club or tennis racquet moves, which allows refinement and improvement in the timing of a radar measurement. Limitations exist on synchronization, but even synchronization to some degree (milliseconds versus microseconds versus nanoseconds) may reduce errors and thereby improve measurements significantly.

The combination of a radar and a camera or Lidar may improve the measurement significantly over that of a single radar measurement. Even if the resolution and number of observations is limited in any of the devices, if they can be aligned in time and their locations known versus the real-world model, three-dimensional trajectories may be extrapolated from the angle resolution from the camera image and the speed measurement of a radar. The Lidar unit may have limited resolution and range, but a few measurements of the distance and angle of a moving object aligned in time and in the physical model with radar measurements of that moving object may improve the accuracy, resolution and range of the measurement of the trajectory of the moving object. The combination of processors, sensors, and the calibration of alignment and timing, may enable further processing to gain more understanding of the trajectory or other attributes of the moving object, such as ball spin and the axis of spin.

Feedback from processing the measurements may improve the accuracy of future measurements because the model obtained by applying the physics for the objects and motions of interest may converge when tested against the results of multiple sensors. The result of the whole of the system may be averaged over several events to give better measurement and alignment over time for a series of events that occur with the same physical constraints, such as hitting a baseball or softball off of a tee. A series of measurements analyzed individually may have ambiguity and uncertainty, but when combined with a sequence of measurements of the same moving object, the system may converge on only one solution that matches the physics of the situation. Thus, even limited sensors, when combined, may provide information enabling better accuracy than might be expected from a lone sensor in a single measurement event.

Summarily, a combination of sensors and one or many computing devices may enable improvements in the accuracy and acquisition of sensor measurements. A combination may determine the timing of the measurement, it may determine or refine the alignment of the various sensors, actors, fixed objects and moving objects involved in the measurement, and a combination of multiple sensors it may enable multi-dimensional resolution of object location and motion where a single sensor could only deliver one dimensional results.

Therefore, there is a need to overcome the limitations in using individual sensors to capture motion data. More specifically, there is a need of a method and system that combines, aligns and calibrates multiple individual sensors—either in arbitrary or fixed positions—to improve the accuracy of measurements taken by the multiple sensors, and thereby to more accurately determine the motion characteristics of a moving object. As set out in the following Brief Summary of the Invention and in the Detailed Description of the Invention, the present invention realizes these objectives and thereby overcomes the limitations in prior art systems.

### BRIEF SUMMARY OF THE INVENTION

In its most essential aspect, the present invention is a system and method for temporally and spatially calibrating sensors using multiple and various sensors and processors. Knowledge of the absolute location and synchronized timing of two or more sensors with respect to objects of interest in space and time enables a system incorporating imperfect or non-optimally located sensors to deliver desired measurement results that any of the sensors alone could not deliver. Using a combination of sensors, the locations and direction vectors of observations of those sensors or other sensors in a system with respect to objects of interest (typically moving objects) may be determined, either automatically or by operator interaction.

Computational algorithms based upon that timing, location and vector data operate on sensor measurements to enable reconstruction of the positions, velocities and accelerations of objects of interest over time. Using this method, the accuracy and capability in determining positions and velocities over time exceeds the capability of a single sensor working alone in non-optimal alignment with the objects of interest.

Sensors mentioned include, but are not limited to, radar, LIDAR, still cameras and motion camera files, accelerometers, magnetic field sensors, microphones, gyroscopes, touch screens and mechanical user interfaces (buttons), and wireless (RF) and optical communication links. Processor algorithms include, but are not limited to, computer vision and object recognition, speech recognition, sound pattern recognition, three-dimensional dead reckoning, a priori knowledge of the physics of motion of objects of interest, and best fit optimization of prediction of motion related to observed sensor data sensing that motion.

Embodiments of the present invention thus provide a method and system to align and calibrate a plurality of sensors to determine the location of the plurality of sensors relative to a moving object and to the world and/or a local field of interest. Determining the relative locations of sensors enables the combination of those sensors to obtain increasingly accurate multidimensional results from one or two-dimensional sensors.

In embodiments, the inventive method comprises automatically determining spatial locations and orientations of both sensors and objects of interest using a plurality of sensors and processor algorithms. The method also provides a confidence enhancement technique for measurements from the plurality of sensors. A prediction model is built to provide an initial estimate of the trajectory of moving objects. The model is then refined either by feeding and processing real time data, or processing data in the cloud, from the plurality of sensors. The initial estimate is modified to provide an accurate determination of the motion characteristics of the moving object(s). [As used herein, the term “cloud” refers simply to remote servers having data processing, programs, and/or data storage accessible through the Internet rather than locally, on-device.]

Accordingly, embodiments disclosed herein provide a method of aligning and calibrating sensor measurements to determine the motion characteristics of a moving object. In a most essential aspect, the method includes (1) calibrating and aligning a plurality of sensors for a multi-dimensional field of interest, based on one or more of motion data of the moving object, spatial data, location, and timing synchronization of the plurality of sensors, to obtain first measurements; (2) determining an initial estimate of the motion of a moving object, including an estimate of one or more of the location, velocity, spin, and spin axis (i.e., the orientation) of the moving object from a section of the sequence of measurements; (3) comparing an additional set of measurements with the determined initial estimate to modify the initial estimate, wherein the additional set of measurements are obtained from the plurality of sensors; and (4) determining the motion characteristics of the moving object based on the modification of the initial estimate.

In embodiments, the plurality of sensors includes a first sensor including a radar, and a second sensor including a camera, wherein the second sensor is coincident in location and observation direction with the first sensor.

In further embodiments, the camera is located at one side of the trajectory of motion of the moving object. The camera may be optimally, though not necessarily, located at approximately 90 degrees to an approximate mid-point in the trajectory of the object's motion during the motion of the moving object.

According to some embodiments, the plurality of sensors includes at least two radar units at calibrated locations (which may be either relative or absolute), and that the individual radar units are placed at different positions along a non-straight line to define a plane.

In still other embodiments, the plurality of sensors includes a lidar unit having angular and distance measurement capability.

According to some embodiments, the plurality of sensors includes a lidar unit and a camera enabling alignment of the lidar measurements with a calibrated location and orientation (again, either relative or absolute).

In further embodiments, the plurality of sensors includes a lidar unit calibrated to a known location and direction relative to the moving object using a combination of sensors to determine the position and velocity of the moving object.

In embodiments the calibration involves determining sensor location and orientation by observation of the plurality of sensors and known points along or aligned with the trajectory of the moving object. This may be accomplished using physical measurements, dead reckoning using lidar, gyroscope, accelerometer, Global Position Satellite (“GPS or GNSS”) data, Wifi Positioning System (“WFPS”) or mapping software (including online mapping software), or any combination thereof.

According to some embodiments the calibration further includes determining sensor location and orientation by image recognition, wherein the location is marked by either user intervention or an image recognition algorithm.

In embodiments the timing synchronization and/or spatial/location synchronization is accomplished using electrical or optical means over wireless, wired, fiber optic, or free space transmission media.

In other embodiments the calibration includes one or more of marking the time when the moving object changes position and/or starts or stops motion, by combining information from plurality of sensors at calibrated locations and at known relative times, and thus to determine the velocity and the time taken by the moving object to change location or to be detected at known locations over a period of time.

In yet other embodiments, the system may derive the start time of a moving object by sensing and measuring the velocity radar versus time.

In still further embodiments, the calibration includes determining the locations of the sensors and known points on the trajectory of the moving object by physical measurement, lidar, wireless radio frequency link time of flight and direction, dead reckoning using gyroscope, accelerometer, WFPS or GNSS data, and online mapping software, or combinations thereof.

According to some embodiments, the calibration further comprises determining locations of the plurality of sensors and known points on the trajectory of the moving object by image recognition, wherein the location is marked by one of user intervention or image recognition algorithm.

According to some embodiments, the time is determined by using a microphone sensor to detect a sound characteristic of an event to mark a plurality of such events.

In further embodiments, the time is determined by image analysis of plurality of images including one or more of still photographs or time marked series of video frames captured by a camera to mark a plurality of events. Alternatively, time can be determined by input from an external sensor, such as a sensor located on a a barrier wall, a fence, or a net, or on a part of an athlete's body or equipment.

In embodiments the measurement of a repeating series of trajectories of the moving object with one or more common points along each trajectory enables the generation of a prediction model, i.e., an estimated model, for the location of the sensors (single or plurality) and the common points of the trajectories. The model utilizes the physics of motion of the moving object under observation and the estimate of the locations to improve the accuracy of further estimates of actual trajectories from measured data.

From the foregoing, those with skill in the art will appreciate that the present invention is a system and method of using an interconnected multi-sensor array wherein the sensors may be set up in an entirely arbitrary way as long as the positions are not redundant. When deployed and in use, the sensors locate one another, self-calibrate, compute the relative locations, automatically calculate the outcome on the velocity and/or trajectory of a moving object (e.g., horizontal and vertical launch angle and spin calculations. Where a moving ball will go is readily determined more accurately. The system provides a highly flexible approach that can be deployed in the real world in real-world sport environments. It can be coupled with machine learning AI or expert system AI flowcharts to provide coaching at a distance through laptop GUIs and display.

The foregoing summary broadly sets out the more important features of the present invention so that the detailed description that follows may be better understood, and so that the present contributions to the art may be better appreciated. There are additional features of the invention that will be described in the detailed description of the preferred embodiments of the invention which will form the subject matter of claims, provisionally appended hereto but subject to revision in any non-provisional application subsequently filed and claiming priority to the instant application.

Accordingly, before explaining the preferred embodiment of the disclosure in detail, it is to be understood that the disclosure is not limited in its application to the details of the construction and the arrangements set forth in the following description or illustrated in the drawings. The inventive apparatus described herein is capable of other embodiments and of being practiced and carried out in various ways.

### BRIEF DESCRIPTION OF SEVERAL VIEWS OF THE DRAWINGS

The invention will be better understood and objects other than those set forth above will become apparent when consideration is given to the following detailed description thereof. Such description makes reference to the annexed drawings wherein:

FIG. 1 is a highly schematic block diagram illustrating an environment for a calibration system of the present invention;

FIG. 2 is a schematic block diagram of a general multi-sensor architecture, in accordance with an embodiment of the present invention;

FIG. 3 is also a schematic block diagram of a multi-sensor architecture with both cloud and on-device processing, in accordance with an embodiment of the present invention;

FIG. 4 is yet another schematic block diagram of a multi-sensor architecture operating in the cloud, in accordance with an embodiment of the present invention;

FIG. 5A shows a combination of radar and lidar used to capture data of a moving baseball;

FIG. 5B is a schematic view showing how the lidar and radar of the system of FIG. 5A may be synchronized to increase the accuracy of measurements;

FIG. 5C is a schematic view illustrating how the true speed of an object may be calculated by combining distance, speed, and pointing vector data, here showing a combination of data captured by radar and lidar;

FIG. 6A is a schematic view illustrating an exemplary combination of a first radar data with a second radar data;

FIG. 6B shows how radar data is combined by a calibration system to provide an initial estimate of the trajectory of moving ball;

FIG. 6C shows how the initial estimates as provided in FIG. 6B can be validated by taking new measurements from the sensors;

FIG. 7 is a flowchart showing an embodiment of the method steps involved in calibrating sensor measurements to determine the motion characteristics of a moving object; and

FIG. 8 shows an exemplary combination of multiple sensors of a calibration system, in accordance with another embodiment of the present invention.

### DETAILED DESCRIPTION OF THE INVENTION

In the following detailed description, references may be made regarding servers, services, or other systems formed from computing devices. Those with skill should appreciate that the use of such terms is understood to represent one or more computing devices having at least one processor configured or programmed to execute software instructions stored on a computer-readable tangible, non-transitory medium, also referred to as a processor readable medium. A server can include one or more computers operating as a web server, data source server, or other type of computer server in a manner to fulfill described functions. In this disclosure, the computing devices are understood to include a processor and a non-transitory memory storing instructions executable by the processor that cause the device to control, manage, or otherwise manipulate the features of the devices or systems.

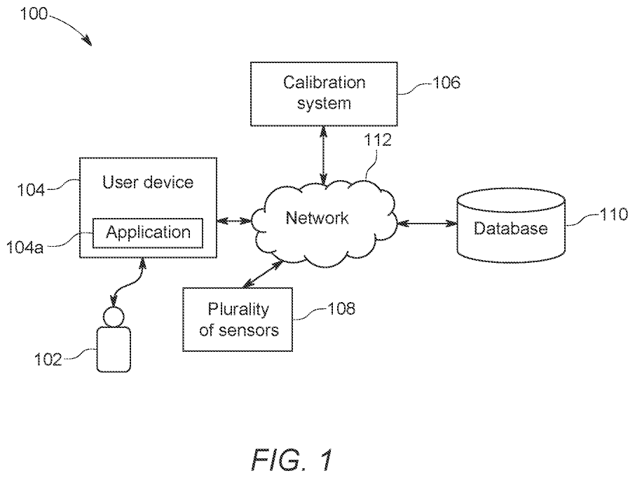

FIG. 1 illustrates an environment representation 100 for a calibration system 106, in accordance with an embodiment of the present invention. A user 102 has a user device 104 to access the calibration system 106. The user device 104 may include, but is not limited to, a desktop computer, a laptop, a smart mobile phone, and a portable handheld device used for communication. The user 102 may set up an account for tracking the motions of moving objects via an application interface 104a in the user device 104. The application interface may also be hosted by a system, such as the calibration system 106.

To set up an account, the user 102 provides data corresponding to the user 102 in the application interface 104a. The data includes information about the user 102, such as user name, user address, and the like. The calibration system 106 transmits detected motions of moving objects to the user device 104 via a network 112.

The network 112 may include suitable logic, circuitry, and interfaces that may be configured to provide a plurality of network ports and a plurality of communication channels for the transmission and reception of data. Each network port may correspond to a virtual address (or a physical machine address) for the transmission and reception of the communication data. For example, the virtual address may be an Internet Protocol Version 4 (IPv4) (or an IPv6 address or future communication standards) and the physical address may be a Media Access Control (MAC) address or future physical address standards.

The network 112 may be associated with an application layer for implementing communication protocols based on one or more communication requests from at least one device in the plurality of communication devices. The communication data may be transmitted or received via the communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZIGBEE®, Edge, infrared (IR), IEEE 802.11, 802.16, cellular communication protocols, and/or Bluetooth (BT) communication protocols. [ZIGBEE is a registered trademark of Philips Electronics North America Corporation.

Examples of the network 112 may include, but are not limited to, a wireless channel, a wired channel, and a combination of wireless and wired channel thereof. The wireless or wired channel may be associated with a network standard that may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a Long Term Evolution (LTE) network, a plain old telephone service (POTS), and a Metropolitan Area Network (MAN). Cellular network technology standards such as 4G and 5G are encompassed within the scope of the invention. Additionally, the wired channel may be selected on the basis of bandwidth criteria. For example, an optical fiber channel may be used for a high bandwidth communication. A coaxial, cable-based, or Ethernet-based communication channel may be used for moderate bandwidth communication.

The calibration system 106 obtains data from a plurality of sensors 108 via the network 112. The plurality of sensors 108 may include one or more of radar, lidar, camera, smart phone sensors such as accelerometers, gyroscopes, compasses, microphones, cameras, and a multitude of infrared, optical or radio frequency links, such as Bluetooth, Wifi, Zigbee, and infrared sensors. The calibration system 106 enables calibration of the plurality of sensors 108 by enabling time synchronization and location synchronization between the sensors 108. The data from the sensors 108 may be referred as spatial data. The spatial data may include but are not limited to one or more of location, position, orientation and the like of the plurality of sensors relative to the moving objects. The calibration system may determine the motion characteristics of the moving objects based on the data from the plurality of sensors 108. Motion characteristics of the moving object may include but are not limited to speed, trajectory, angle, position, spin, and motion duration. As is well known, one of the motion characteristics of the moving object may also include relative velocity, as detected from a radar unit configured to sense and consider its own velocity relative to a reference. Further, the calibration system may be configured to make a plurality of measurements of a moving object having varying speeds in discrete events so as to enable calibration and enhancement of the calibration of the location of a starting point for a measured motion, such as a ball tee or a pitching mound or the like.

The calibration system 106 stores the data from the plurality of sensors 108 in a database 110. In embodiments, the database 114 may be integrated into the calibration system 106. In another embodiment, the database 110 may be remotely connected to the calibration system 106 via the network 112. In some embodiments, the calibration system 106 may store user information in the database 110.

In some embodiments the calibration system may also store an initial estimate of the attribute of the moving object in the database 110. The initial estimate stored in the database 110 is modified by the calibration system 106 using data from the plurality of sensors 108 to determine the motion characteristics of the moving objects. The user 102 may access the motion characteristics of the moving objects stored in the database 110 via the user device 104 connected to the network 112.

The calibration system 106 may be embodied as a cloud-based service or within a cloud-based platform.

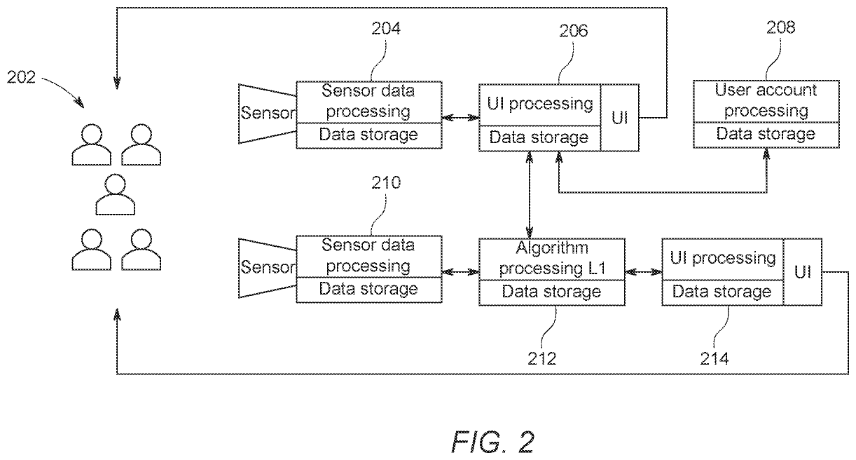

Turning next to FIG. 2, an embodiment of the calibration system 106 is illustrated in a schematic block diagram of a general multi-sensor architecture. This multi-sensor architecture comprises sensor units 204, 210, which provide sensor data processing and data storage. The sensor units 204, 210 may store sensor measurements in the data storage and may perform local processing of the sensor measurements in the sensor data processing unit.

Sensor measurements may vary depending on the type of sensor used. For example, if radar is used as the sensor, the radar may measure changes in phase of a transmitted radio signal reflected from the moving object. Further, the radar device may sense the portion of a speed vector of the moving object aligned along the path of the transmitted radio signal. If lidar is used as the sensor, the lidar may transmit a laser signal and observe the amplitude and timing of a reflected laser signal using an array of sensors. In still another example, if a smartphone camera is used as the sensor, the camera may capture images of the moving object. Further still, the calibration system of the present invention contemplates use of a lidar sensor with multiple receivers able to provide an array of distance measurements at each angle of each individual receiver sensor. This differs from conventional law enforcement lidar in which a single beam uses a single receiver sensor aimed with a telescope at a license plate or similar reflector on an automobile. Advantageously, each of the receiver sensors in a multi-sensor lidar could deliver a range at that known sensor angle, enabling construction of a point cloud for a single measurement time and a sequence of point clouds using a sequence of measurements.

Sensor measurements from the sensor units may be transmitted to the algorithm processing unit 212, which may utilize one or more of computer vision and pattern recognition (cs.CV), machine learning (cs.LG), image and video processing (eess.IV), data pattern recognition (DSP), speech and sound recognition, point cloud 3D modeling, dead reckoning, time series analysis, Fourier transformation algorithms, analog/digital signal processing techniques, best fit optimization algorithms, artificial intelligence (AI), and the like, all to enable the alignment of objects and sensors to points and vectors in time and space. The alignment of sensors enables predicting the trajectory of moving objects. The algorithm processing unit 212 combines the sensor measurements to achieve extended range, higher certainty and improved accuracy of the measurement from the sensors 204, 210. The predicted trajectory of the moving objects may be provided to a user 202 via User Interface (UI) processing units 206, 214 that provide an interface to the user 202. The user 202 may access information related to the moving objects or information related to the sensor measurements via the user interface processing units. Again, information related to the user 202 may be stored in a user account processing unit 208. The information related to the user 202 may include a user profile, photograph, name, age, sex, sport played, device name, sport equipment name, and the like.

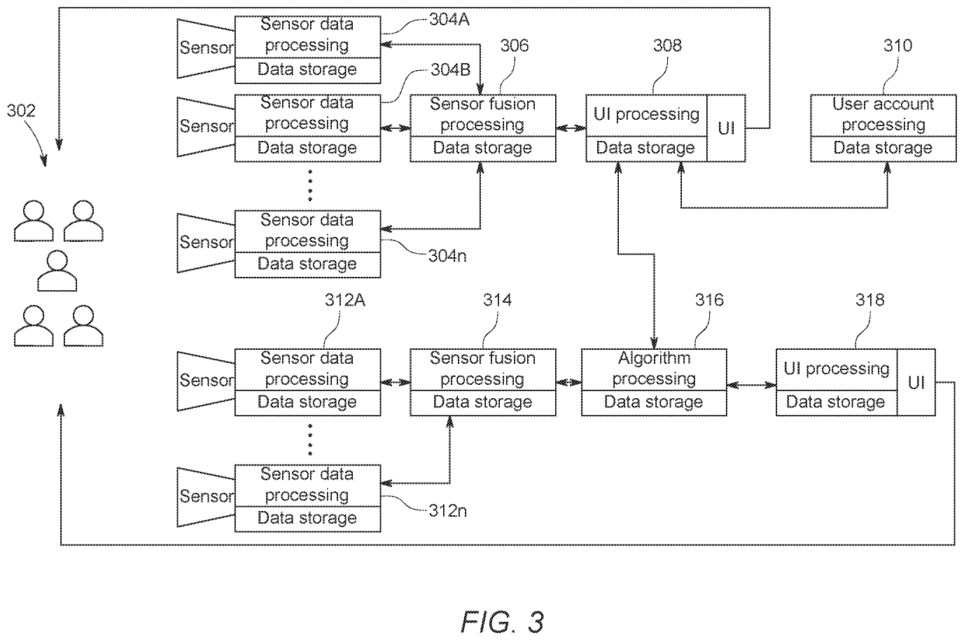

Turning next to FIG. 3, it will be seen that measurements from the sensors may be processed on-device or in the cloud. FIG. 3 is a schematic block diagram of a multi-sensor architecture with both cloud and on-device processing. The calibration system shown in FIG. 3 includes a plurality of sensor units. Measurements from the sensors may be processed by sensor data processing units coupled to the sensors. The sensor data processing units performing onboard (i.e., on device processing) are referred to as on-device sensor processing units 304A, 304B, . . . , 304n). The sensor data processing units performing processing in the cloud may be referred to as cloud sensor processing units (312A, 312B, . . . 312n). Data from the plurality of sensor data processing units may be combined in sensor fusion processing units. The sensor fusion unit that provides a fusion of sensor measurements on device is referred to as a sensor fusion processing unit 306. Similarly, the sensor fusion unit providing a fusion of sensor measurements in the cloud may be referred to as sensor fusion processing unit 314. The fused data from the sensor fusion processing unit 314 operating in the cloud is obtained directly by an algorithm processing unit 316. The fused data from the sensor fusion processing unit 306 operating on device is obtained by the algorithm processing unit 316 via a user interface processing unit 308. The algorithm processing unit 316 may be operated in the cloud. In an embodiment, the algorithm processing unit 316 may be operated on device. The algorithm processing unit 316 applies algorithms on the fused data obtained from the sensor fusion processing units 306, 314.

Again, the algorithms applied by the algorithm processing unit 316 may correspond to one or more of visual pattern recognition (CV), data pattern recognition (DSP), speech and sound recognition, point cloud 3D modeling, dead reckoning, best fit optimization, time series analysis, Fourier transformation algorithms, analog/digital signal processing techniques, AI, machine learning, and the like. The algorithm processing unit 316 may perform calibrations of the plurality of sensors and time synchronization of the plurality of sensors. Further, the algorithm processing unit 316 may determine the motion characteristics of the moving object based on the algorithm applied on the fused data from sensor fusion processing units 306, 314. The motion characteristics of the moving objects may be presented to a user 302 by the user interface processing units 308, 318. The user interface processing unit 318 may operate in the cloud. The user interface processing unit 308 may operate on device. The user 302 may set up a personal account and provide details related to the user 302. The details related to the user 302 may be stored in user account processing unit 310. The data related to the plurality of sensors, fused data, algorithm, determined motion characteristics of moving objects, and user data may be stored in the database (110 in FIG. 1). The user 302 may upload sensor measurements obtained from the plurality of on-device sensor data processing units 304A, 304B, . . . 304n to the algorithm processing unit 316 operating in the cloud via the user interface processing units 308, 316. The algorithm processing unit 316 may then change the position and orientation of the plurality of sensors by providing instructions to the sensor data processing units 304A, . . . 304n, 312A, . . . 312n based on the output of the algorithms used on the sensor measurements.

In use, a user typically places a radar unit at a fixed location in relation to the movement or motion to be measured. The objective is to determine the location and pointing vector of any sensor relative to the world, plus the locations of the playing field, the objects moving, and the people acting upon those objects. For applications in baseball or softball, the user may place and secure a radar on a tripod or on a fence or backstop or pitching net, or the like. That mounting structure may be located behind the catcher or above the catcher on the backstop. Two additional radars may be located (as an example) at each dugout, each pointed at the pitcher or hitter. Knowing their locations and the direction of the radar beams, one can combine simultaneous measurements of speed and obtain true velocity as a vector in 3 space coordinates tied to the world coordinates and the field coordinates.

Alternatively, and by way of another example of possible use, several radar units may be located near to one another at known separations and known distances from one another and from a hitting tee. All may be fixed in location. If their respective locations and the location of a hitting tee are known, then the combination of measured speeds can provide data relating to the true velocity vector and the trajectory or series of locations with respect to the time the ball is hit off the tee. The same principle of combining sensors applies to a combination of Lidar, camera, or other similar sensors. Some of such sensors deliver speed, some deliver angle or distance at angle versus time. All may be combined by converging the model of the physics of motion of the object with the observed data. A best fit between the physical model and the observations provides the best velocity and trajectory estimate.

In yet another example of a potential application, several sensor units may be mounted around a volleyball or tennis court to provide similar results in tracing the velocity vector and location of a ball, especially in a serve.

All of these examples require synchronizing the timing of each separate sensor measurement. All of these examples also require some sort of knowledge of the position in 3 space coordinates of the sensors, objects, world, field and actors. With multiple sensors integrated into one package, such as when using a smart phone with a camera, lidar, compass, gyroscope, GPS or other location device, and an accelerometer, a user might sense the phone's motion or location as well as the motion of observed objects.

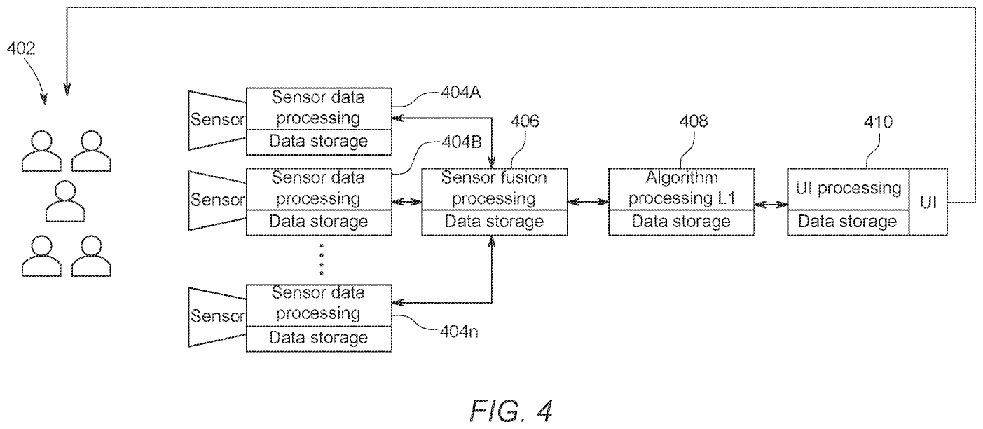

In an embodiment, the calibration system 106 may operate entirely in the cloud as illustrated in FIG. 4, which is a schematic block diagram of a multi-sensor architecture operating in the cloud. The multi-sensor architecture comprises a plurality of sensors. The plurality of sensors is controlled by network connected sensor data processing units 404A, 404B, . . . 404n operating in the cloud. Data from the sensor processing units 404A, 404B, . . . 404n is combined by a sensor fusion processing unit 406. The combined data is termed fused data. The fused data is processed by an algorithm processing unit 408, which applies an algorithm to the fused data to determine motion characteristics of moving objects. The motion characteristics of moving objects may be accessed by a user 402 via a user interface processing unit 410. Referring back now to FIG. 1, the calibration system (FIG. 1 106) implementing the FIG. 4 multi-sensor architecture operating in the cloud reduces memory and computational requirements from the user device. The multi-sensor system operating in the cloud also increases the efficiency of the calibration system.

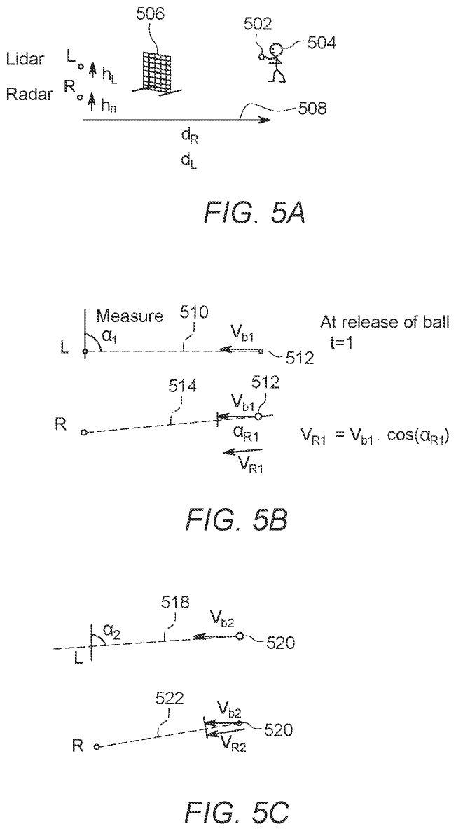

Combining data from the plurality of sensors by the calibration system is explained in FIG. 5, which show an exemplary combination of radar data with lidar data. The calibration system is quite usefully adapted for use in sports for tracking moving objects, such as balls. In an example, as shown in FIG. 5A, the calibration system may be utilized in baseball to track and determine the motion characteristics of a moving baseball 502. Because the cross-sectional surface area of a baseball 502 is small, reflected signals are reduced resulting in potentially unreliable measurements. Therefore, a plurality of sensors such as a lidar sensor L is placed along with a radar sensor R for accurate calibration. The lidar L and radar R are placed at calibrated three-dimensional coordinates. For instance, the lidar and the radar can be placed behind a pitcher's protective barrier, such as a net or fence 506 such that they capture the baseball 502 thrown by a player 504 at close distance. The net 506 may also be a backstop. The distance 508 between the lidar and the baseball varies as the ball moves from the pitcher 504 to a batter or catcher. The varying distance 508 between the lidar and the baseball 502 is signified by dL. Similarly, the varying distance 508 between the radar and the baseball 502 is signified by dR. Further, the distance between the ground and the lidar may be referred as lidar height hL, and the distance between the ground and the radar R may be referred as radar height hR.

FIG. 5B shows that the lidar and the radar may be synchronized to increase the accuracy of measurements. Synchronization may be triggered by marking the beginning of an event at time t=1. Time may be marked by sounds characteristic of the event environment, such as a bat hitting a ball, a ball hitting a catcher's mitt, the striking of a tennis ball with a racquet, a hockey stick striking a puck, or the server's hand hitting a volleyball. The motion of a pitcher, server, batter or other athlete or actor may be detected through image or other types of processing from a multitude of types of sensors to determine the end point or beginning of an action of motion, marking the time for other sensors to determine and refine their contribution. Combining multiple sensor inputs reduces the uncertainty, increases the range (distance from sensor) or improves the accuracy of that result.

When implemented as a sensor system to capture data on pitching, the beginning of an event may be marked by the release of the baseball 512 from the player 504., typically a pitcher. The baseball 502 may move at a velocity V. The velocity of the baseball 512 is a vector referred to as velocity vector Vb1. The baseball 512 is sensed by the lidar L, and the distance between the baseball 512 and the lidar L is indicated at 510. The baseball 512 is also sensed by the radar R. The radar R may track the pointing vector VR1 of the baseball 512. The distance between the radar R and the baseball 512 is indicated as distance 514. The radar device R will only sense the portion of the speed vector aligned along the path of transmitted radio signal and not the true speed of the moving object. Further the radar does not have angle resolution capability. Therefore, the lidar L is used to determine the angle between the lidar and the baseball 512, referred to as alpha α₁. The alpha angle is combined with the velocity vector Vb1 to obtain an accurate pointing vector VR1, the combination given by the formula VR1=Vbl.cos(α₁R1).

As shown in FIG. 5C, the lidar L may measure the angle alpha α₂ between the baseball 520 and the lidar L. The distance between the lidar L and the baseball 520 is referred to as the distance 518. The baseball 520 has a velocity vector Vb2. The distance between the radar R and the baseball 520 is identified as the distance 522. As can be inferred from FIG. 5C, there is a clear mismatch between the velocity vector Vb2 and the radar pointing vector VR2. The radar may take only the radar pointing vector Vr2, which is not the true speed of the baseball 520. Rather, the true speed is calculated by combining the radar measurement with the lidar data as given by the formula VR2=Vb2.cos(α₂.R2).

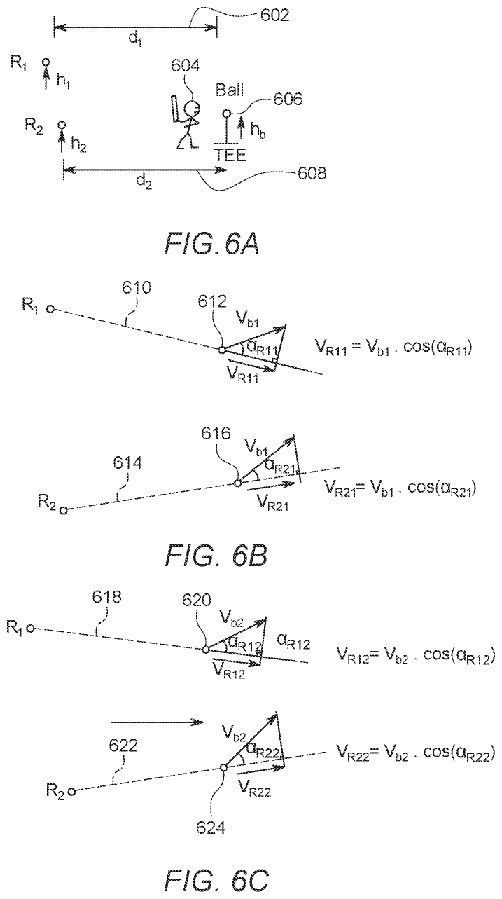

In another embodiment, the plurality of sensors may also be placed at different locations along a non-straight line and calibrated by the calibration system 106 of FIG. 1 as shown in FIGS. 6A-6C. FIG. 6A shows data capture using a first radar with a second radar, in accordance with another embodiment of the present invention. As shown in FIG. 6A, a first radar R1 and a second radar R2 are placed at different locations with respect to a baseball 606. The distance between the ball 606 and the first radar R1 is referred to as d1 and identified with reference number 602; the distance between ground and the first radar R1 is referred to as h1. Similarly, the distance between the ball 606 and the second radar R2 is referred to as d2, and identified with reference number 608, and the distance between ground and the second radar R2 is referred to as h2. The distance between the ball 606 and the ground is referred as h_{b}. It will be appreciated, that while the illustrations show a sensor located behind a net, the sensor can be usefully and advantageously located on the protective barrier itself.

When a player 604 hits the ball 606, the calibration system may predict the trajectory of the ball 606. Hitting the ball may trigger an action for time synchronization between the two radars R1 and R2. As shown in FIG. 6B, the radar R1 may sense the ball at a position 612 different from a position 616 sensed by the radar R2. The distance between R1 and the position 612 is referred to as distance 610. Similarly, the distance between R2 and the position 616 is referred to as distance 614.

As can be seen in FIG. 6B, the angle between velocity vector Vb1 of the ball and radar pointing vector VR11 sensed by the radar R1 is referred as aR11. The radar pointing vector is given by the formula VR11=Vbl.cos(αR11). Similarly, the angle between velocity vector Vb1 of the ball and the radar pointing vector VR21 sensed by the radar R2 is referred to as αR21. The radar pointing vector is given by the formula VR21=Vb1.cos(αR21). The radar data is combined by the calibration system to provide an initial estimate of the trajectory of the ball. The calibration system applies algorithms to predict subsequent points of calibration for the radars R1 and R2. The initial estimates can be validated by taking new measurements from the radars R1 and R2 as illustrated in FIG. 6C.

Referring, then, to FIG. 6C, a new position 620 of ball is sensed by the radar R1. The radar R1 also measures the changed position 618 between the radar R1 and the ball 620. The ball 620 has a velocity vector Vb2. The radar R1 may sense pointing vector VR12 of the ball 620 and not the true speed. The difference in angle between the velocity vector Vb2 and the radar pointing vector VR12 is given by aR12. The pointing vector VR12 is given by the formula VR12=Vb2.cos(αR12). Similarly, a new position 624 of ball is sensed by the radar R2. The radar R2 also measures a new distance 622 between the radar R2 and the ball 624. The ball 624 has a velocity vector Vb2. The radar R2 may sense a pointing vector VR22 of the ball 624 and not the true speed. The difference in angle between the velocity vector Vb2 and the radar pointing vector VR22 is given by αR22. The pointing vector VR22 is given by the formula VR22=Vb2.cos(αR22).

As is clear, the data from radars R1 and R2 are thus combined for the calibration and prediction of motion characteristics of moving objects, here exemplified as a baseball. Note that the system is configured to calculate or model the estimate of distances 618 and 622 using the velocity measurements and models from kinematics, the physics of moving objects. Measurement of a sequence of velocities over time enables matching the observation with the model to converge upon a trajectory and the actual velocity of the object or ball versus time as well as converging upon better location estimates for the radar devices and the moving object starting point.

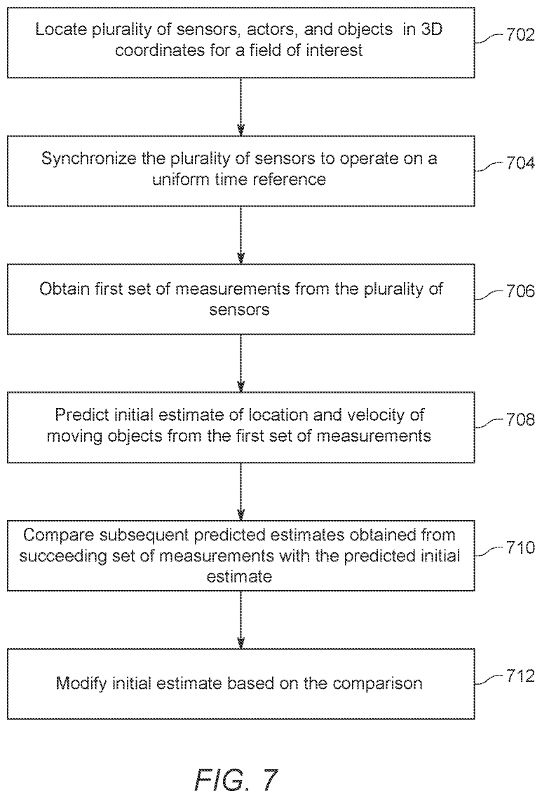

The method followed by the calibration system to determine motion characteristics of the moving objects is illustrated in a flowchart in FIG. 7. Here we see that at step 702, a plurality of sensors, actors, and objects are located in three dimensional coordinates for a field of interest. The actors may correspond to players and other conditions found in sporting activity environment.

At step 704, the plurality of sensors is synchronized to operate on a uniform time reference. The time reference is determined by detecting a characteristic sound or action (an event) to mark the sensing of events by the sensors.

At step 706, a first set of measurements are obtained from the sensors. The first set of measurements from the sensors is combined as discussed in detail in FIG. 6.

At step 708, an initial estimate of the location and velocity of moving objects is predicted from the first set of measurements. The calibration system may utilize known laws of physics of the moving object's motion and may use initial estimates of drag (air resistance, coefficients of drag) and Magnus effects (from spin) as well as gravity effects operating on the known mass, size, and features of the moving object to predict the initial estimate of the location and velocity of the moving object.

At step 710, a succeeding set of measurements is obtained from the sensors. The succeeding set of measurements is used by the calibration system to produce subsequent predicted estimates. The subsequent predicted estimates are compared with the predicted initial estimate.

At step 712, the predicted initial estimate is modified based on the comparison done in step 710. The method steps are repeated until an estimate that best fits with real world data is obtained.

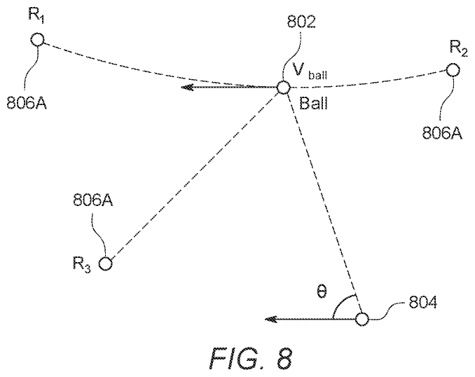

FIG. 8 shows an exemplary combination of multiple sensors of a calibration system. The multiple sensors may be radars R1, R2, R3 (806A) and a camera 804 for instance, a smartphone camera. The multiple sensors 806A, 804 may be synchronized in time to create simultaneous measurement records. The multiple sensors are placed at known locations and orientations, each for sensing a moving object, e.g., a ball 802, having a velocity vector V_{ball}. The camera 804 may capture images of the moving object 802, and the captured images may be subjected to image processing algorithms to determine the location of the sensors and known points on the trajectory of the moving object. Image processing enables identification of changes in an image, recognizes patterns previously identified in an image, or may identify changes in the location of a particular recognized pattern over time. These patterns can include a human body, a moving bat, tennis racquet, or other sports implement, a fixture on a playing field, such as home plate in a baseball game, or a net in a volleyball game, or objects on a factory floor, such as machinery, a forklift, or moving bottles along a conveyer path. Any arbitrary object might be identified and observed using image processing and proper programming or training of the image processing system.

The camera 804 may also measure angle θ of the moving object 802 relative to the camera sensor. Similarly, each radar R1, R2, and R3, may sense the projection of ball speed on the radar pointing vector. The pointing vector may be given by the formula VR=V_{ball}·cos (α), where α is the angle in three dimensional coordinates between the radar pointing vector and the velocity vector V_{ball} of the moving object 802. The camera measurement and the radar measurements are combined to obtain accurate values of location and orientation of the multiple sensors 806A, 804. Based on the accuracy, the multiple sensors are calibrated by the calibration system. The combined data is then processed by the calibration system using computational algorithms and the laws of physics to predict an initial estimate of the trajectory of the moving object. Subsequent measurements from the multiple sensors are then compared with the predicted initial estimate. Based on the comparison, the initial estimate is modified to reflect actual real-world data. The combination of multiple sensors enables measurement with less computational complexity, more sensitivity and more confidence or certainty in the measurement results of the multiple sensors.

In an embodiment, the system may include the use of multiple cameras (e.g., smartphone cameras) in combination with multiple radars or other sensors. However, in most instances, the system will use a single sensor with a wireless link (e.g., Bluetooth low energy) to a single camera, and the system may be configured to keep any single sensor or other sensor linked to a single phone or processing unit. That unit may aggregate multiple radar or sensor units or it may be combined with higher level processing through remote cloud processing. The radar or other sensor can then have its speed and timing forwarded to the cloud for observation by multiple other users running a similar app to observe the data that the system delivers. This applies equally to multiple sensors such as a lidar or other sensors. Multiple phones or cameras may supply multiple video or still images for further distribution or analysis, as shown in FIGS. 2-4.

As will be appreciated, the inventive system includes the critical step of capturing the locations of the various objects, sensors, or actors. Smartphones may provide a distinct advantage in such a step when used in connection with other sensors. For instance, a lidar may deliver angle and distance data, but a smartphone can analyze a camera image and with image processing to determine the angle to each point of interest, whether fixed or movable, such as the ball or player in a game as well as just the location of the pitching mound or home plate and the hitter or pitcher. The phone can use the other sensors in the system to detect motion or location and with additional images and processing to determine not only angle, but the full three-dimensional coordinates of the points and people of interest. In use, a user might walk around the field of play using multiple methods to track the phone location or relative location and mark the locations or points of interest instead of using image processing or lidar to determine those points. The objective is to make the calibration or measurement of location easy to accomplish for users unfamiliar or unskilled in the task of aligning the sensors, thus freeing them to direct their attention to understanding the measurements and what to do about them, not requiring them to understand the technical aspects of sensor features and functions and how to make them run. The system combines data from the sensors to deliver known coordinates, then combines the sensors with knowledge of location, vectors, and timing to produce useful information regarding object motion.

The above disclosure is sufficient to enable one of ordinary skill in the art to practice the invention and provides a preferred mode of practicing the invention as presently contemplated by the inventors. While there is provided herein a full and complete disclosure of the preferred embodiments of this invention, it is not desired to limit the invention to the exact construction, dimensional relationships, and operation shown and described. Various modifications, alternative constructions, changes and equivalents will readily occur to those skilled in the art and may be employed, as suitable, without departing from the true spirit and scope of the invention. Such changes might involve alternative materials, components, structural arrangements, sizes, shapes, forms, functions, operational features or sensors now unforeseen but developed in the future and which perform the same or substantially the same functions as those described herein.

Therefore, the above description and illustrations should not be construed as limiting the scope of the invention, which is defined by claims presented herein.

What is claimed as invention is:

1. A method of calibrating sensor measurements to determine motion characteristics of a moving object, the method comprising:
aligning and calibrating a plurality of sensors for a multi-dimensional field of interest based on motion data of the moving object and spatial data;
timing the synchronization of the plurality of sensors to obtain first measurements or a record of measurements;
determining an initial estimate of one or more of the location, velocity, spin, and spin axis of the moving object from the data of an initial subset of the measurement record;
comparing data from an additional set or sets of measurements taken subsequently to the initial subset with the determined initial estimate to modify the initial estimate, wherein the subsequently taken set or sets of measurements are obtained from the plurality of sensors; and
determining the motion characteristics of the moving object based on the modification of the initial estimate.

2. The method of claim 1, wherein the plurality of sensors comprises:
a first sensor including a radar; and
a second sensor including a camera located in a position different from the radar.

3. The method of claim 2, wherein the position of the camera is at one side of the trajectory of motion of the moving object.

4. The method of claim 1, wherein the plurality of sensors includes at least two radar units at calibrated locations, and further wherein the radar units are placed at different positions in relation to the starting point of the moving object.

5. The method of claim 1, wherein the plurality of sensors includes a lidar unit having distance measurement capability.

6. The method of claim 1, wherein the plurality of sensors includes a lidar unit having angle measurement capability.

7. The method of claim 1, wherein the plurality of sensors includes a lidar unit having distance and angle measurement capability.

8. The method of claim 1, wherein the plurality of sensors includes a lidar unit and a camera, the camera enabling alignment of the lidar measurements with calibrated location and orientation.

9. The method of claim 1, wherein the plurality of sensors includes a lidar unit aligned and calibrated to a known location and direction relative to the moving object using a combination of sensors to determine the position and velocity of the moving object.

10. The method of claim 1, wherein the alignment and calibration step comprises determining location and orientation by observations of the plurality of sensors and known points along or aligned with the trajectory of the moving object using one or more of physical measurement, dead reckoning using lidar, gyroscope, accelerometer, WFPS or GPSS data, laser distance measurement, and online software.

11. The method of claim 1, wherein the alignment and calibration step further includes determining location and orientation by image recognition, wherein the location is marked by either user intervention or an image recognition algorithm.

12. The method of claim 1, wherein the alignment and calibration step further includes determining location and orientation by multiple cameras sensing and determining their locations relative to one another based on a known marker within each of their respective visual field.

13. The method of claim 1, wherein the timing synchronization step involves using electrical or optical means over wireless, wired, fiber optic or free space transmission media.

14. The method of claim 1, wherein the alignment and calibration step comprises one or more of:
marking the time when the moving object changes position, starts, or stops motion, wherein this step includes combining information from a plurality of sensors at calibrated locations and at known relative times to determine both the speed and the time taken by the moving object to change locations or is detected at known locations over a period of time.

15. The method of claim 1, wherein the calibration step comprises:
determining the locations and orientations of the plurality of sensors and known points on the trajectory of the moving object by one or more of physical measurement, lidar, wireless radio frequency link time of flight and direction, dead reckoning using gyroscope, accelerometer, WFPS or GPSS data, laser distance measurement and mapping software.

16. The method of claim 1, wherein the alignment and calibration step further comprises:
determining the location and orientation of the plurality of sensors and known points on the trajectory of the moving object by image recognition, wherein the location is marked by either user intervention or an image recognition algorithm.

17. The method of claim 1, wherein the time is determined by detecting a characteristic sound to mark a plurality of events.

18. The method of claim 1, wherein the time is determined by analyzing an image of a plurality of images comprising one or more of still photographs or a time-marked series of video frames captured by a camera to mark a plurality of events.

19. The method of claim 1, wherein measuring a repeating series of trajectories of the moving object with one or more common points along each trajectory enables convergence of an estimated model for the location of the plurality of sensors and the common points of the trajectories, wherein the model utilizes the physics of motion of the moving object under observation and the estimate of the locations to improve the accuracy of estimates of an actual trajectory from the measured data.

20. A system implemented on a plurality of network-connected sensors and a network-connected computer, comprising:
at least one network-connectable computer having a processor and memory;
wherein said at least one network-connectable computer is programmed with software which, when executed, enables said network-connectable computer alone or in combination with other network-connectable computers to receive measurement data from said plurality of network-connected sensors when the sensors are coincident in neither location nor in observation direction, said measurement data relating to the motion of a moving object; to store the measurement data; to align and calibrate the network-a plurality of network-connected sensors based on motion data of the moving object and spatial data; to use the measurement data to build a prediction model of one or more of the location, velocity, spin, and spin axis of a moving object from a subset of the measurement data; to receive subsequently captured data from said plurality of network-connected sensors; to modify the prediction model based on all or part of the subsequently captured data; and to determine the motion characteristics of the moving object based on the modification of the prediction model.

21. The system of claim 20, further configured to time the synchronization of said plurality of network-connected sensors to obtain first measurements or a record of measurements.

22. The system of claim 21, further configured to detect a characteristic sound to determine the time for timing the synchronization of said plurality of network-connected sensors to mark a plurality of events.

23. The system of claim 21, further configured to analyze an image of a plurality of images including one or more of still photographs or a time-marked series of video frames captured by a camera to determine the time for timing the synchronization of the plurality of network-connected sensors to the mark a plurality of events.

24. The system of claim 21, wherein timing the synchronization of said plurality of network-connected sensors is carried out using transmitted electrical or optical signals over wireless, wired, fiber optic, or free space transmission media.

25. The system of claim 20, wherein said plurality of network-connectable sensors includes first and second sensors, wherein said first sensor is a radar and said second sensor is a camera.

26. The system of claim 25, wherein the position of said camera is at one side of the trajectory of motion of the moving object.

27. The system of claim 26, wherein said plurality of network-connected sensors includes at least two radar units at calibrated locations, and further wherein the radar units are placed at different positions in relation to the starting point of the moving object.

28. The system of claim 20, wherein said plurality of network-connected sensors includes a lidar unit having distance measurement capability.

29. The system of claim 20, wherein said plurality of network-connected sensors includes a lidar unit having angle measurement capability.

30. The system of claim 20, wherein said plurality of network-connected sensors includes a lidar unit having distance and angle measurement capability.

31. The system of claim 20, wherein said plurality of network-connected sensors includes a lidar unit and a camera, wherein said camera is configured to enable alignment of lidar measurements with calibrated location and orientation.

32. The system of claim 20, wherein said plurality of network-connected sensors includes a lidar unit aligned and calibrated to a known location and direction relative to the moving object using a combination of sensors to determine the position and velocity of the moving object.

33. The system of claim 20, wherein the system is further configured such that the alignment and calibration of said plurality of network-connected sensors includes determining location and orientation by observations of said plurality of network-connected sensors and known points along or aligned with the trajectory of the moving object using one or more of physical measurement, dead reckoning using lidar, gyroscope, accelerometer, WFPS or GPSS data, laser distance measurement, and online mapping software.

34. The system of claim 20, wherein the alignment and calibration of said plurality of network-connected sensors includes determining location and orientation using an image recognition algorithm.

35. The system of claim 20, wherein the alignment and calibration of said plurality of network-connected sensors includes determining location and orientation using multiple cameras configured to sense and determine their locations relative to one another based on a known marker within each of their respective visual field.

36. The system of claim 20, wherein the alignment and calibration of said plurality of network-connected sensors includes marking the time when the moving object changes position, starts, or stops motion and combines information from the plurality of network-connected sensors at calibrated locations and at known relative times to determine both the speed and the time taken by the moving object to change locations.

37. The system of claim 20, further configured to calibrate said plurality of network-connected sensors by determining the locations and orientations of said plurality of network-connected sensors and known points on the trajectory of the moving object by one or more of physical measurement, lidar, wireless radio frequency link time of flight and direction, dead reckoning using gyroscope, accelerometer, WFPS or GPSS data, laser distance measurement and online mapping software.

38. The system of claim 20, further configured determine the location and orientation of said plurality of network-connected sensors and known points on the trajectory of the moving object by image recognition, wherein the location is marked using an image recognition algorithm.

39. The system of claim 20, further configured to measure a repeating series of trajectories of the moving object with one or more common points along each trajectory, develop an estimated model for the location of said plurality of network-connected sensors and the common points of the trajectories, and use the physics of motion of the moving object under observation and the estimate of the locations to improve the accuracy of estimates of an actual trajectory from the measured data.
